(19) United States
(12) Patent Application Publication
(10) Pub. No.: US 2002/0183054 A1
(43) Pub. Date: Dec. 5, 2002

(54) Mobile system testing architecture

(76) Inventors: Yoram Rimoni, Haifa (IL); Amit Gil, San Diego, CA (US)

Correspondence Address: QUALCOMM Incorporated, Attn: Patent Department, 5775 Morehouse Drive, San Diego, CA, 92121-1714, US

(21) Appl. No.: 10/118,721

(22) Filed: Apr. 8, 2002

Related U.S. Application Data
(60) Provisional application No. 60/282,664, filed on Apr. 9, 2001.

(51) Int. Cl. H04Q 7/20

(52) U.S. Cl. 455/423; 455/424; 455/425

(57) ABSTRACT

Apparatus for testing one or more mobiles, each mobile being adapted to transmit and receive respective signals compatible with a cellular communications network. The apparatus includes station simulation circuitry which is adapted to simulate a plurality of base station controllers (BSCs) operative simultaneously in the cellular communications network. The apparatus also includes mobile interface circuitry which is coupled to transfer the respective signals between the station simulation circuitry and the one or more mobiles.

### RELATED APPLICATIONS

This application claims priority to U.S. Provisional Patent Application No. 60/282,664, filed on Apr. 9, 2001.

### CROSS-REFERENCE TO RELATED APPLICATIONS

This application is related to a U.S. patent application entitled “Mobile Transceiver State Machine Testing Device,” [Attorney Docket No. 000083] filed on even date, which is assigned to the assignee of the present application and which is incorporated herein by reference.

### FIELD OF THE INVENTION

The present invention relates generally to testing systems, and specifically to testing cellular communications networks.

### BACKGROUND OF THE INVENTION

Testing systems for mobile communication products are known in the art. Tektronix Inc., of Portland, Oreg. produce a CMD80 digital communications test set which simulates a mobile communications operating environment and makes measurements on a mobile unit coupled to the CMD80. In the CMD80, a user is able to define test parameters of a network, such as a mean power and variations of the power of a signal from a base station, and measure the effects on a mobile combined transmitter and receiver. A mobile combined transmitter and receiver is herein termed a mobile.

Cellular networks, and components of the networks, such as base stations and mobiles, which communicate with one another, typically operate according to international standards. For example code division multiple access (CDMA) networks operate or will operate in the future according to standard IS-95 and/or successor standards such as a globally-harmonized International Mobile Telecommunications (IMT)—2000 standard. IMT-2000 is a third generation (3G) CDMA standard, comprising narrowband CDMA and wideband CDMA (W-CDMA) operations. Standards for operating cellular networks and their components, such as IMT-2000, are available from the International Telecommunication Union, of Geneva, Switzerland, as computer-readable files. Testing procedures for the standards are also available in Tree and Tabular Combined Notation (TTCN) format.

U.S. Pat. No. 5,809,108 to Thompson, et al., whose disclosure is incorporated herein by reference, describes a test system for a mobile telephone. The system captures signaling data from the origination and termination sides of test calls. A test case generator builds new test calls by presenting to a user a menu for each step in the new test call. The user creates test calls by selecting list items and by entering keyboard data related to the item where appropriate.

U.S. Pat. No. 5,875,397 to Sasin, et al., whose disclosure is incorporated herein by reference, describes apparatus and a method for testing telephone communications equipment. The test apparatus includes a central signal processor and a programmable data processor for the generation of digital test signals for testing the telephone communications equipment. There is a converter connected with the programmable data processor. The converter is constructed so that it converts the digital test signals of the data processor, under the control of telephone specific configuration data, into signals for controlling the operation of the keypad and of the microphone of the telephone via a connector. The converter also converts answer signals received from the loudspeaker and from the calling apparatus of the telephone into digital operating answer signals and transfers the signals to the programmable data processor, where they are saved or evaluated.

U.S. Pat. No. 6,011,830 to Sasin, et al., whose disclosure is incorporated herein by reference, describes a test device and a method of executing a test for a system which can assume a number of operating states. The device is stated to be particularly suitable for testing a mobile telephone network, such as a Global System for Mobile (GSM) communications network, e.g. for interrupting connection lines therein. A test case generator is provided for generating a number of test cases which are sent via a test device interface to the system under test. A test state model of the system is formulated by a test state model generator using information on the hardware configuration and other parameters of the system. Test commands are generated on the basis of a Monte-Carlo simulation of this test state model.

Methods for producing software elements from graphic elements such as flow charts are known in the art. For example, Visio Enterprise, produced by Visio Corporation of Seattle, Wash., is a graphic package which enables the generation from a graphic of a state machine to code in a number of computer languages such as UML (Universal Modeling Language).

The M. S. Thesis of Paul J. Lucas (University of Illinois at Urbana-Champaign, technical report: UIUCCS-R-94-1868), which is incorporated herein by reference, describes a language for implementing a concurrent hierarchical state machine (CHSM). The CHSM language is a text-based language for specifying state charts. A state chart is a formal method for graphically specifying a state machine. State charts have an advantage compared with state transition diagrams, in that the charts comprise child and parent states.

### SUMMARY OF THE INVENTION

It is an object of some aspects of the present invention to provide an improved method and apparatus for testing a cellular mobile.

It is a further object of some aspects of the present invention to provide a method and apparatus for simultaneously simulating operation of a plurality of base station controllers and base station transceivers within a cellular transmission network.

In preferred embodiments of the present invention, one or more mobiles are coupled to a simulator of a cellular communications network in order to test each mobile. The simulator comprises a plurality of elements. A station core simulator acts as a first element which simulates management functions and operations, at a digital level, of one or more base station transceivers (BTSs) and/or one or more base station controllers (BSCs). The simulation performed by the core simulator comprises allocation of channels, with appropriate channel parameters, for communication between the BTSs/BSCs and the mobiles, and provides a digital output. A second element of the simulator operates as an interface between the first element and the mobiles being tested. The second element performs digital-to-digital and digital-to-RF conversions, so as to simulate RF communication between the one or more base stations and each of the mobiles under test via the allocated channels, and to incorporate “real-world” signal effects into the channels. Operating parameters of each of the elements of the network simulator can be configured and controlled independently by an operator.

In operation, the simulator receives test instructions via a test script that is input by the operator, and incorporates the script into a test which comprises parameters which can change dynamically. Tests may be designed to be adversarial or non-adversarial. In an autonomous operation mode, the simulator performs tests on one or more of the mobiles after all of the simulator elements have been configured, by a test script, so that the system operates in a “well-behaved” mode. Tests on all of the mobiles are performed substantially simultaneously, and are independent one from another. Thus, a single network simulator simulates one or more BTSs, one or more BSCs, and channels used for communication, in order to independently test a number of mobiles simultaneously. Using one configurable simulator to perform tests enables significant savings in time to be made, while maintaining testing flexibility and verisimilitude, compared to methods known in the art.

In some preferred embodiments of the present invention, the test script is written in Tree and Tabular Combined Notation (TTCN) language. The script most preferably incorporates one or more test procedures written in TTCN, so that the script may be used to directly test one or more of the mobiles under test against the standards. In another preferred embodiment of the present invention, the test script is written in a general purpose computer language known in the art.

In some preferred embodiments of the present invention, one or more parameters within the simulator are set so that a plurality of BTSs are connected in different topologies.

In some preferred embodiments of the present invention, one or more parameters within the simulator are set so that a plurality of operators are able to use the simulator simultaneously.

In some preferred embodiments of the present invention, the simulator is set to operate in a combination of autonomous and non-autonomous modes.

There is therefore provided, according to a preferred embodiment of the present invention, apparatus for testing one or more mobiles, each mobile being adapted to transmit and receive respective signals compatible with a cellular communications network, the apparatus including:

station simulation circuitry, which is adapted to simulate a plurality of base station controllers (BSCs) operative simultaneously in the cellular communications network; and

mobile interface circuitry, which is coupled to transfer the respective signals between the station simulation circuitry and the one or more mobiles.

Preferably, the mobile interface circuitry includes channel simulation circuitry, which is adapted to simulate one or more communication channels via which the respective signals are conveyed between the station simulation circuitry and the one or more mobiles.

Further preferably, the channel simulation circuitry includes one or more digital circuit boards (DCBs), wherein the one or more DCBs are adapted to simulate one or more of effects selected from a group consisting of noise, fading, attenuation, delay, Doppler shift, and reflection.

Preferably, the station simulation circuitry includes one or more components adapted to simulate one or more base station transceivers coupled to the plurality of BSCs.

Preferably, the station simulation circuitry is adapted to transfer data to and from a public switched telephone network (PSTN).

Preferably, the station simulation circuitry is adapted to transfer data chosen from a group consisting of asynchronous data, fax data, and packet data.

Preferably, the apparatus includes a system controller coupled to the station simulation circuitry and the mobile interface circuitry, which system controller enables a plurality of users to test the one or more mobiles simultaneously.

Preferably, the controller includes a database wherein are stored one or more parameters defining the plurality of BSCs.

Further preferably, the database includes parameters defining a plurality of topologies describing connections between the plurality of BSCs.

Preferably, the database includes one or more behavior models, wherein each of the one or more behavior models describes one or more procedures followed by at least one of the plurality of BSCs.

Preferably, the database includes one or more test scripts input by the one or more users for testing the one or more mobiles.

Further preferably, the one or more test scripts include one or more executable files respectively defining one or more procedures followed by at least one of the plurality of BSCs.

Preferably, the one or more test scripts include scripts written in Tree and Tabular Combined Notation (TTCN).

Preferably, the station simulation circuitry is adapted to simulate management of communication channels of the plurality of BSCs.

Preferably, the communication channels include communication channels selected from a group consisting of pilot, paging, synchronization, and access channels.

Further preferably, the communication channels include forward and reverse dedicated communication channels.

Preferably, one or more mobiles include one or more mobile station modem devices.

There is further provided, according to a preferred embodiment of the present invention, a method for testing one or more mobiles, each mobile being adapted to transmit and receive respective signals compatible with a cellular communications network, the method including:

processing the respective signals in station simulation circuitry so as to simulate operation of a plurality of base station controllers (BSCs) in communication with the one or more mobiles in the cellular communications network, thus to produce processed signals; and

transferring the processed signals between the station simulation circuitry and the one or more mobiles.

Preferably, transferring the processed signals includes simulating one or more communication channels used to transfer the signals.

Further preferably, simulating the one or more communication channels includes simulating one or more of effects selected from a group consisting of noise, fading, attenuation, delay, Doppler shift, and reflection in channel simulation circuitry.

Preferably, processing the signals includes processing the signals so as to simulate operation of one or more base station transceivers coupled to the plurality of BSCs.

Preferably, testing the one or more mobiles includes testing the one or more mobiles under control of a plurality of users simultaneously.

Preferably, testing the one or more mobiles includes inputting one or more test scripts to the station simulation circuitry.

Preferably, processing the signals includes defining one or more topologies describing connections between the plurality of BSCs, and processing the signals in accordance with at least one of the defined topologies.

Preferably, processing the signals includes constructing one or more behavior models, wherein each of the one or more behavior models describes one or more procedures followed by at least one of the plurality of BSCs, and processing the signals in accordance with at least one of the behavior models.

Preferably, the method includes simulating management of communication channels of the plurality of BSCs.

Preferably, testing the one or more mobiles includes testing one or more mobile station modem devices.

The present invention will be more fully understood from the following detailed description of the preferred embodiments thereof, taken together with the drawings, in which:

### BRIEF DESCRIPTION OF THE DRAWINGS

FIG. 1 is a schematic diagram of a testing system, according to a preferred embodiment of the present invention;

FIG. 2 is a schematic diagram showing sections comprised in a test configuration, according to a preferred embodiment of the present invention;

FIG. 3 is a block diagram showing elements comprised in a station core simulator comprised in the testing system of FIG. 1, according to a preferred embodiment of the present invention;

FIG. 4 is a schematic block diagram illustrating a channel simulation unit comprised in the testing system of FIG. 1, according to a preferred embodiment of the present invention;

FIG. 5A is a state chart illustrating a call setup procedure followed by a base station controller (BSC), and FIG. 5B is a message flow diagram showing messages transferred between the BSC and a mobile when the setup procedure occurs, according to a preferred embodiment of the present invention; and

FIG. 6 is a schematic flow chart illustrating a process used to produce a behavioral model executable file corresponding to a procedure followed by a BSC, according to a preferred embodiment of the present invention.

### DETAILED DESCRIPTION OF PREFERRED EMBODIMENTS

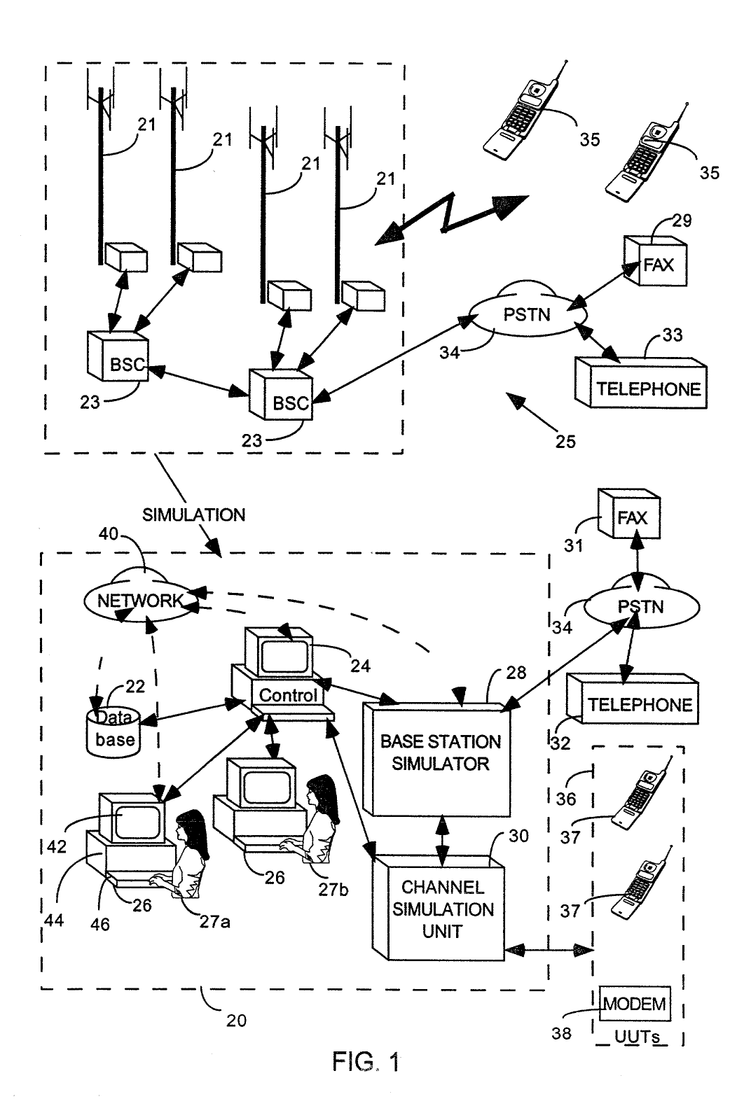

Reference is now made to FIG. 1, which is a schematic diagram of a testing system 20, according to a preferred embodiment of the present invention. Testing system 20 simulates communications between one or more generally similar base transceiver stations (BTSs) 21, one or more base station controllers (BSCs) 23, and one or more generally similar mobile units 35 operating within a cellular communications network 25. Testing system 20 also simulates communications between a public switching telephone network (PSTN) 34, comprising, for example, a land-based telephone 33 and/or a data transmission device 29 such as a fax machine, and network 25.

In system 20 a base station simulator 28 comprises components which are used to generate a simulation of operations performed by the one or more BSCs 23 and the one more BTSs 21, each BTS being controlled by a specific BSC 23. Simulator 28 generates signals which simulate the activity of the one or more BSCs, and so acts as a base station simulation system. Simulator 28 is coupled, most preferably via PSTN 34, to a terrestrial telephone 32 and a data transmission device 31, which are respectively substantially similar to telephone 33 and data transmission device 29. A channel simulation unit 30, comprising mobile interface circuitry, is implemented to simulate one or more cellular network channels for conveying signals between simulator 28 and one or more units-under test (UUTs) 36.

Simulator 28 is coupled by industry-standard means, such as an Ethernet connection, to unit 30. Unit 30 is also coupled to one or more UUTs 36. UUTs 36 most preferably comprise one or more mobiles 37 which have been designed to receive and transmit signals compatible with signals produced by the one or more BTSs 21. Alternatively or additionally, the one or more UUTs 36 comprise one or more mobile station modem devices 38 which can receive and transmit signals compatible with signals produced by the one or more BTSs 21. Preferably, the signals within network 25 and simulated by system 20 are CDMA signals. Alternatively, the signals are of a type compatible with a different industry-standard cellular network, such as time division multiple access (TDMA). The coupling between unit 30 and the UUTs is preferably by wireless coupling. Alternatively, unit 30 is coupled to the UUTs by other standard means via which cellular network signals can transfer, such as coaxial cable. The implementation and operation of simulator 28 and unit 30 are described in more detail hereinbelow.

System 20 further comprises a controller 24 which controls operations of simulator 28 and unit 30, and which is preferably implemented as an industry-standard personal computer. Controller 24 is coupled to unit 30, to system simulator 28, and to a database 22 wherein are stored parameters, test messages, and test signals used by the controller in performing tests on the UUTs. The coupling between controller 24, system simulator 28, and database 22 is preferably by cable wherein signals to and from the controller are sent directly. Alternatively, the coupling is via a distributed network 40, for example the Internet. System 20 also comprises one or more clients 26 which are able to operate and receive results of tests performed on the UUTs via controller 24. Each client 26 is most preferably implemented as an industry-standard personal computer, and is coupled to controller 24 directly or indirectly as described above.

Each client 26 most preferably comprises a monitor 42, a non-volatile memory 44, and an input device 46 such as a computer pointing device or a keyboard. Each client 26 further most preferably is operated by a respective user 27a, 27b, 27c, . . . of system 20. Users 27a, 27b, 27c, are referred to collectively hereinafter as users 27. Users 27 enter instructions via their respective client 26 to system 20, in order to choose and implement one or more tests on one or more UUTs. Results of the one or more tests are preferably received by each user 27 on the user's client 26, wherein the results may be stored.

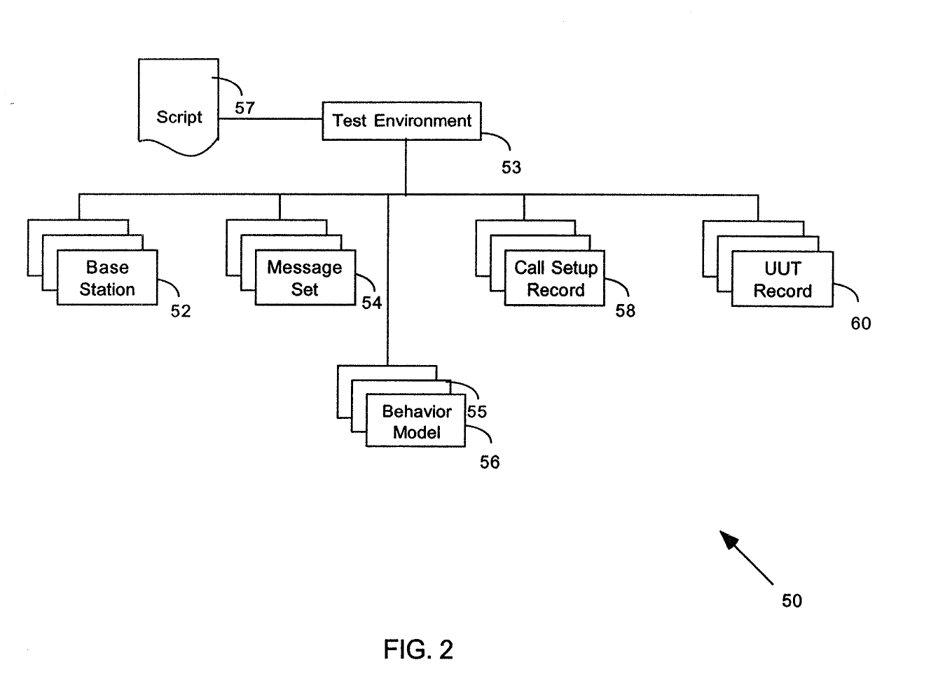

FIG. 2 is a schematic diagram showing sections comprised in a test configuration 50, according to a preferred embodiment of the present invention. Users 27 set parameters within configuration 50 in order to generate one or more tests using system 20. Users 27 most preferably enter the required parameters of the one or more tests using a textual configuration language, as is known in the art, via their respective client 26. Alternatively, each user 27 enters the required parameters of the one or more tests via other means known in the art, such as a graphic user interface on the user's monitor 42. The required parameters are compiled by system 20 and preferably stored within database 22, from where the compiled parameters are retrieved by controller 24 when the one or more tests are performed.

Configuration 50 comprises:

A base station section 52, which section enables users 27 to define a respective configuration of one or more logical BSCs to be used in a specific test. In section 52 each user 27 defines one or more cells within each BSC, and one or more sectors within each of the defined cells. For each sector, users 27 define which sectors are to be considered as neighboring sectors. Also for each sector, each user 27 defines channels used within the sector, and attributes of the channels. Thus, within section 52, a complete topology of a system is defined. The types of channels, and their attributes, are described in detail hereinbelow.

A message set section 54, which enables users 27 to create messages and formats of messages to be used during a test. Messages are preferably of two types: general messages comprising control messages and layer 3 messages; and sector messages comprising messages broadcast within a specific sector, such as overhead channel messages or any other message used within a behavior model (described in detail below).

A UUT record section 60, which enables users 27 to specify one or more UUTs which are to be tested.

A call setup record section 58, which enables users 27 to specify call setup parameters to be used during a test.

A behavior model section 56, comprising one or more behavior models 55. Each behavior model 55 is a respective procedure performed during a test, each procedure corresponding to one or more specific state charts describing the operation of a base station. The construction and implementation of behavior models is described in detail hereinbelow.

A test environment section 53, which calls one or more test scripts 57, most preferably generated by each user 27 before a test on system 20 is run. Section 53 acts as an envelope containing the other sections of configuration 50. A test run on system 20 may be implemented in an autonomous mode, wherein sections 52, 54, 56, 58, and 60 are defined by each user 27 according to one or more specific test scripts 57 which cause system 20 to operate in a “well-behaved” manner. Alternatively or additionally, section 53 is able to call one or more test scripts 57 which cause system 20 to operate in an adversarial or a non-adversarial manner. Preferably, the one or more scripts 57 are written as respective authoring scripts, to operate within system 20, by methods known in the art. Alternatively or additionally, the one or more scripts 57 are written in Tree and Tabular Combined Notation (TTCN). As described in the Background of the Invention, test procedures for standards for network 25 may be generated as TTCN files, so that such files can be incorporated into test script 57 to check if one or more specific standards are met.

As stated above with respect to base station section 52, each user 27 defines channels used within each sector. Preferably, all channels are defined according to the IMT-2000 standard.

Each sector comprises one or more paging channels and/or quick-paging channels, defined by each user 27 by most preferably assigning each paging channel attributes as shown in Tables I and II hereinbelow. Tables I and II show an attribute name and a corresponding description of the attribute. Most preferably, each user 27 defines up to 7 paging channels and up to 3 quick paging channels for each sector.

TABLE I

| Attribute Name | Attribute Description |
|---|---|
| PageType | Paging or quick paging channel. |
| Rate | Half or full-rate transmission. |
| EncodeRate | One quarter or one half of full-rate channel |
| | transmission. |
| FrameDur | A maximum frame period used by the channel. |
| Gain | A gain level for transmission. |
| WalshCH | Walsh Channel number. |
| QUASI_OF | One of four quasi-orthogonal function values. |
| LongCodeMask | Long Code Mask for the channel. |
| SrchWinSize | A search window size in pseudo-noise (PN) chips. |
| PreamSize | A size of the preamble of an access channel associated |
| | with this paging channel. |
| CapSize | A size of the data of an access channel associated with |
| | this paging channel. |
| OTDmode | Enable/disable orthogonal transmit diversity. |

If attribute PageType in Table I is set to define a channel as paging, i.e., not quick paging, each user 27 most preferably assigns each paging channel further attributes as shown in Table II hereinbelow.

TABLE II

| Attribute Name | Attribute Description |
|---|---|
| SlotCycleIdx | Slot Cycle Index. |
| T1B | Value of T1b in slot units. |
| RptSlot | Number of times a message can be repeated if the |
| | channel is operating in a slotted mode. |
| RptnSlot | Number of times a message can be repeated if the |
| | channel is operating in a non-slotted mode. |
| ReSched | Number of times a message can be re-scheduled. |

Each sector comprises one or more pilot channels, defined by each user 27 by most preferably assigning each pilot channel attributes as shown in Table III hereinbelow. Preferably, each user 27 defines one pilot channel and 3 auxiliary pilot channels for each sector.

TABLE III

| Attribute Name | Attribute Description |
|---|---|
| WalshCH | Walsh Channel number. |
| WalshSQ | Walsh sequence number. |
| Gain | Gain level. |
| QUASI_OF | One of four quasi-orthogonal function values. |
| AddInfo | Sets whether or not additional pilot information is sent as |
| | part of a channel assignment message. |
| OTDpwrLevel | An orthogonal transmit diversity power level measured |
| | relative to that of a Forward Pilot Channel. |

Each sector comprises one or more synchronization (sync) channels, defined by each user 27 by most preferably assigning each sync channel attributes as shown in Table IV hereinbelow. Preferably, each user 27 defines one sync channel for each sector.

TABLE IV

| Attribute Name | Attribute Description |
|---|---|
| Gain | Gain level. |
| LCstate | A bit position of the LC_STATE field. |
| SysTime_POS | A bit position of the SYS_TIME field. |
| TranPeriod | Period for transmission, in integer multiples of 80 ms. |

Each sector comprises access channels, defined by each user 27 by most preferably assigning each access channel attributes as shown in Table V hereinbelow. Preferably, each user 27 defines up to 32 access channels for each paging channel defined as described above in Tables I and II.

TABLE V

| Attribute Name | Attribute Description |
|---|---|
| Access Channel | Up to 32 access channels associated with a given |
| Number | paging channel. |
| MaxRate | Set if the maximum access channel rate is one half or |
| | is full. |
| PNoffsetInit | Offset for a start search mode, measured in PN chips. |
| LongCodeMask | Long Code Mask for the channel. |
| Page Channel | The paging channel this access channel is associated |
| | with. |

Each sector comprises forward traffic channels, defined by each user 27 by most preferably assigning each forward traffic channel attributes as shown in Tables VI and VII hereinbelow. Preferably, each user 27 defines as many forward traffic channels as are allowed by the standard governing the operation of network 25

TABLE VI

| Attribute Name | Attribute Description |
|---|---|
| CHtype | A variable defining the traffic channel type as: a for- |
| | ward dedicated control channel, a forward fundamental |
| | channel, a forward supplemental code channel, or a |
| | forward supplemental channel. |
| RadioCfg | Radio configuration of the channel. |
| MAX_RATE | Maximum rate for the forward channel. |
| FrameDur | Frame duration for the traffic channel. |
| WalshCH | Walsh Channel number. |
| QOF | One of four quasi-orthogonal function values. |
| LongCodeMask | Long Code Mask for the channel. |
| CodeType | Sets whether a coding scheme for the channel is |
| | convolutional or turbo. |
| MuxOption | Sets under which of two multiplex methods the |
| | channel operates. |
| SupIdx | If CHtype is set so that the traffic channel is a forward |
| | supplemental channel or a forward supplemental code |
| | channel, SupIdx is an index of the channel. |

Each forward traffic channel is also most preferably assigned attributes which relate to power levels of the traffic channel, as shown in Table VII hereinbelow.

TABLE VII

| Attribute Name | Attribute Description |
|---|---|
| FPwrMinGain | A forward power control minimum gain. |
| FPwrMaxGain | A forward power control maximum gain. |
| FPwrStepUp | A forward power control step up size. |
| FPwrStepDown | A forward power control step down size. |
| FPwrPunc | A variable setting a forward power control puncturing |
| | mode. |
| RPwrPunc | A reverse power-control puncturing frequency for the |
| | channel. The frequency is one of the frequencies 800 Hz, |
| | 400 Hz, 200 Hz, 0 Hz (in which case puncturing is |
| | disabled). |
| PwrInit | A variable setting an initial power setting. |
| PwrInitSetPnt | An initial outer loop Eb/Nt setpoint in units of 0.125 dB. |
| PwrMinSetPnt | Minimum outer loop Eb/Nt setpoint in units of 0.125 dB. |
| PwrMaxSetPnt | Maximum outer loop Eb/Nt setpoint in units of 0.125 dB. |
| PwrFER | Target frame error rate. |

Each sector comprises reverse traffic channels, defined by each user 27 by most preferably assigning each reverse traffic channel attributes as shown in Tables VIII hereinbelow. Preferably, each user 27 defines as many reverse traffic channels as are allowed by the standard under which BTS 21 is being simulated.

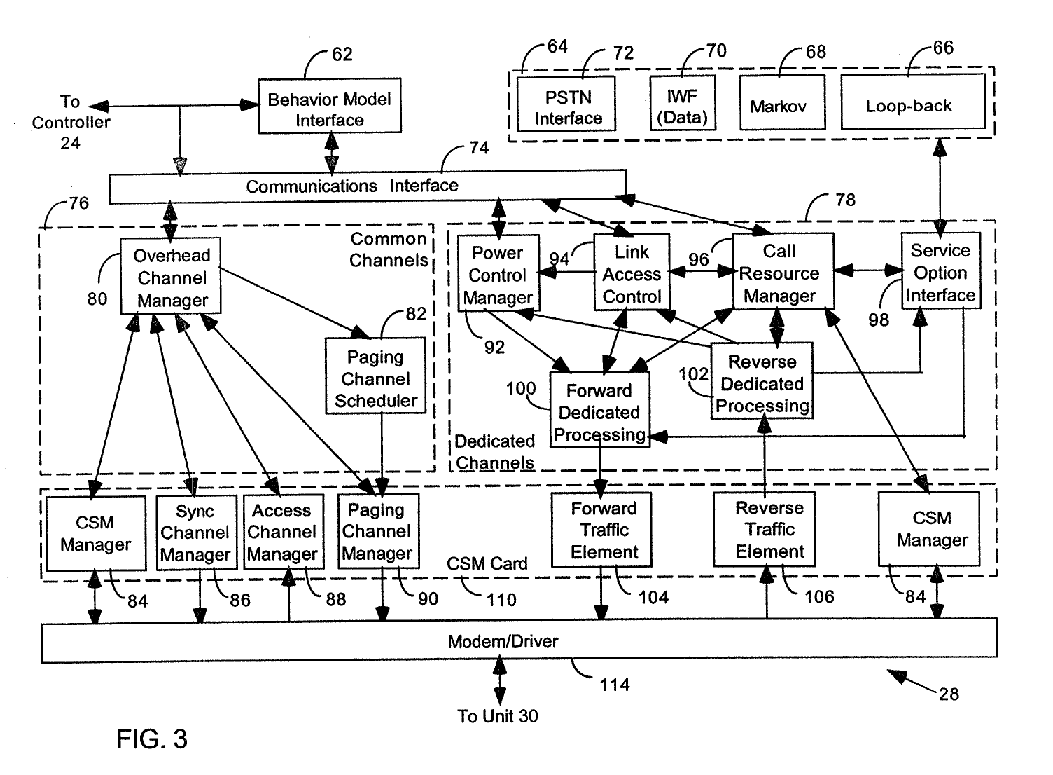

TABLE VIII

| Attribute Name | Attribute Description |
|---|---|
| CHtype | The traffic channel type as one of: reverse dedicated |
| | control channel, reverse fundamental channel, reverse |
| | supplemental code channel, or reverse supplemental |
| | channel. |
| RadioCfg | Radio configuration. |
| MAX_RATE | Maximum rate. |
| FrameDur | Frame duration, set to be 5 ms, 10 ms, 20 ms, 40 ms, |
| | or 80 ms. |
| CodeType | Decoding scheme for the channel as convolutional or |
| | turbo. |
| PwrSetPnt | Power control set point in multiples of 0.25 dB. |
| PwrPattern | Power control up/down pattern, having values of 0 dB, |
| | 25 dB, 50 dB, or 100 dB. |
| CenterSrch | Search center offset measured in chipX8 units. |
| WinSize | Search window size in PN chips. |
| SrchMode | Search mode as either preamble or data. |
| IntPeriod | A multiplier setting an integration period for the |
| | channel in multiples of 1.25 ms corresponding with the |
| | period set by a power control manager 92 component |
| | (as described with respect to FIG. 3 below). The |
| | multiplier is one of the values 1, 2, 4, 8, 16, or 32. |
| LongCodeMask | Long Code Mask. |
| BinSize | Required bin separation size. |
| WalshCV | If the channel type is set as a reverse supplemental |
| | channel, WalshCV is a variable setting a Walsh Cover |
| | value for the channel. |
| MuxOption | Under which of two multiplex methods the channel |
| | operates. |
| SupIdx | If CHtype is set so that the traffic channel is a reverse |
| | supplemental channel or a reverse supplemental code |
| | channel, SupIdx is an index of the channel. |

FIG. 3 is a block diagram showing elements comprised in station simulator 28, according to a preferred embodiment of the present invention. Except as stated hereinbelow, elements within simulator 28 are instantiated as software components in station simulation circuitry, most preferably implemented as one or more industry-standard memory devices. The components are preferably written in an industry-standard computer language such as C++. Station simulator 28 simulates management operations performed within a CDMA base station, the management operations comprising allocation of channels and assignment of channel parameters. A BSC, as defined by each user 27 in base section 52, most preferably comprises one common signaling channel management section 76 and one dedicated signaling channel management section 78. For each BSC, section 76 and section 78 interface with one or more substantially similar cell site modem cards 110, the number of cards depending on the number of cells defined by the user in base section 52. Each cell site modem card 110 most preferably comprises memory devices wherein are instantiated software components, as described hereinbelow. Software running on each cell site modem card 110 interfaces with interface circuitry, most preferably a respective modem/driver 114 which transfers data between its respective card 110 and channel simulator 30.

For each BSC, common signaling channel management section 76 comprises an overhead channel manager (OCM) component 80, which is controlled via a communications interface component 74 by controller 24. OCM component 80 processes link access control messages, and overhead messages as defined in message section 54, over common channels of the BSC. OCM component 80 also directly manages and controls common signaling channels in system 20, which common channels comprise pilot, synchronization, paging, and access channels, by respectively interacting with a cell site modem manager component 84, a synchronization channel manager component 86, a paging channel manager component 90, and an access channel manager component 88, instantiated in cell site modem card 110. (For clarity, single component 84 is shown in FIG. 3 in two positions.) OCM component 80 receives parameters of the common signaling channels, described above in Tables I-V, from controller 24 via communications interface 74. In addition, OCM component 80 manages and controls, together with a paging channel scheduler component 82, paging channel manager component 90. Most preferably there is one of each of components 84, 86, 88, and 90 for each cell of system 20, according to the number of cells defined by each user 27 in base station section 52. Components 82, 84, 86, 88, and 90, are described in more detail hereinbelow.

Paging channel scheduler component 82 schedules link access control messages and paging records transferred via paging channel slots. Scheduler 82 receives the messages and records from OCM component 80. Scheduler 82 then schedules the messages and records for transmission over the paging channel slots, and transfers these messages and records as ordered frames to the appropriate cell paging channel manager 90.

Each paging channel manager 90 manages the forward common signaling channels of the cell to which it is assigned. In addition, each manager 90 defines all the active paging channels and quick-paging channels of its associated cell by most preferably referring to paging channel attributes as shown in Tables I and II hereinabove. Most preferably, each manager 90 manages up to 7 paging channels and 3 quick paging channels for each sector of its assigned cell. Each manager 90 forwards data generated by the manager to channel simulation unit 30, via a respective modem/driver 114.

Each cell site modem manager 84 is responsible for set-up, tear-down, and configuration, of both common channels and dedicated channels of the CSM card 110 on which it is running. In addition, each manager 84 handles one or more pilot channels of the entire network by most preferably assigning each pilot channel attributes as shown in Table III hereinabove. Most preferably, each manager 84 assigns up to 3 auxiliary pilot channels and 1 pilot channel for each sector of the entire network. Each manager 84 interfaces between OCM component 80 and a call resource manager component 96, whose function is described hereinbelow, in section 78. Each manager 84 also interfaces with channel simulation unit 30, via a respective modem/driver 114.

Each synchronization channel manager 86 manages one or more synchronization (sync) channels of the entire network, by most preferably assigning each sync channel attributes as shown in Table IV hereinabove. Each manager 86 transfers data generated by the manager to channel simulation unit 30 via a respective modem/driver 114.

Each access channel manager 88 manages all reverse common signaling channels of the entire network, by most preferably assigning each access channel attributes as shown in Table V hereinabove. Most preferably, each manager 88 assigns up to 32 access channels for each paging channel. Each manager 88 receives data from channel simulation unit 30 via a respective modem/driver 114.

Call resource manager component 96 is comprised in dedicated signaling channel management section 78. Call resource manager 96 manages the allocation, configuration, control, and de-allocation of resources used by dedicated channels of a specific BSC defined by each user 27 in base station section 52 (FIG. 2). Call resource manager 96 communicates with and is used by controller 24, via communications interface 74, as necessary for the manager to operate. As described above, resource manager 96 interfaces with cell site modem manager 84. Call resource manager 96 performs its tasks by also interacting directly with a link access control component 94, a service option interface component 98, a forward dedicated processing component 100, and a reverse dedicated processing component 102. Components 94, 98, 100, and 102 are described in more detail hereinbelow.

Link access control component 94 manages an automatic repeat request sub-layer and a utility sub-layer of the link access control layer. The automatic repeat request sub-layer provides reliable delivery of signals between communicating BSCs. Most preferably, the delivery of a specific signal is confirmed by the sub-layer autonomously re-transmitting the signal and/or acknowledging receipt of the signal until implicit or explicit confirmation of delivery is achieved. Control component 94 supplies data to a power control manager component 92 which manages forward traffic power control. Most preferably, power control manager component 92 generates updated power control data every 1.25 ms. Power control manager 92 collects data from reverse traffic processes, and responsive to this data provides information for forward traffic channels.

Service option interface component 98 provides a uniform interface to all components comprised in a service option element 64. Element 64 most preferably includes a public switched terrestrial network (PSTN) interface 72 comprising a vocoder, and an inter-working function interface 70 comprising an E1/T1 interface, which respectively couple to telephone 32 and fax/data modem 31. Interfaces 70 and 72 preferably comprise industry-standard interface hardware devices which generate asynchronous data, fax data, and/or packet data. Element 64 also most preferably comprises one or more industry-standard interfaces 66 and 68 which enable loop-back and/or Markov calls to be made. Service option interface component 98 most preferably provides a uniform interface between all components comprised in element 64 and forward and reverse dedicated processing components 100 and 102.

Forward dedicated processing component 100 receives forward signaling messages as frames from link access control 94 and multiplexes the frames with data blocks received from service option interface 98. One of two methods for multiplexing is most preferably provided to component 100 from call resource manager 96, by referring to the MuxOption attribute of the channel, as described in Table VI above. Processing component 100 adds power control parameters, received from power control manager 92, to each frame, and sends the modified frames to one or more forward traffic element components 104 comprised in cell site modem card 110.

Reverse dedicated processing component 102 is responsible for operation of a segmentation and re-assembly sub-layer of the link access control layer. Component 102 receives traffic frames from one or more reverse traffic element components 106 comprised in cell site modem card 110. Most preferably, if a call is in a softer or a soft hand-off mode, component 102 selects a best frame from the plurality of received frames of the call. For each frame received, component 102 evaluates a reverse frame rate and an erasure bit indicator, which indicator is a mobile provided error indication on the forward link to the mobile. Values of the reverse frame rate and the erasure bit indicator are transferred to power control manager component 92. In addition, component 102 de-multiplexes received frames, most preferably according to the same method as used by component 100, and transfers recovered signaling messages to link access control 94 and recovered data blocks to service option interface 98.

Most preferably there is one of each of components 104 and 106 for each cell of system 20, according to the number of cells defined by each user 27 in base station section 52. Components 104 and 106 are described in more detail hereinbelow.

Each forward traffic element 104 receives data from forward processing component 100. The data is forwarded, via a specific modem/driver 114, to channel simulation unit 30. In addition, each forward traffic element 104 handles forward traffic channels by most preferably assigning each traffic channel attributes as shown in Tables VI and VII hereinabove.

Each reverse traffic element 106 receives data, via a specific modem/driver 114, from channel simulation unit 30. The data is forwarded to reverse processing component 102. In addition, each reverse traffic element 106 handles reverse traffic channels by most preferably assigning each traffic channel attributes as shown in Table VIII hereinabove.

Forward link data, i.e., data generated by synchronization channel manager 86, paging channel manager 90, forward traffic element 104, and cell site modem manager 84, are transferred to a respective modem/driver 114. Each modem/driver 114 processes the forward link data and converts them to forward baseband data signals suitable for receipt by simulation unit 30. As described in more detail below, channel simulation unit 30 also generates reverse link baseband data signals. The reverse link signals are converted by a respective modem/driver 114 to reverse link data suitable for processing by access channel manager 88, reverse traffic element 106, and cell site manager 84.

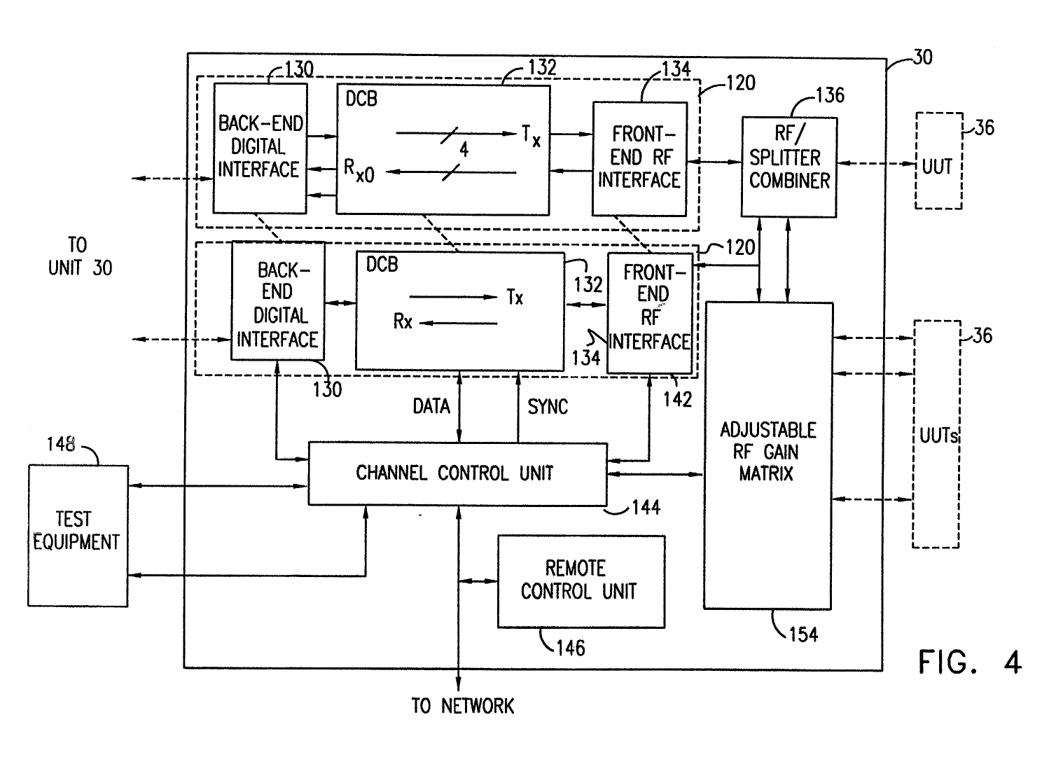

FIG. 4 is a schematic block diagram illustrating channel simulation unit 30, according to a preferred embodiment of the present invention. Unit 30 comprises channel simulation circuitry including a plurality, preferably six, of substantially similar sections 120, each of which sections transmits forward link and reverse link signals. Unit 30 links station simulator 28 with one or more units under test (UUTs) 36. Preferably, each section 120 transfers signals for one sector.

On a forward link, each section 120 is coupled to receive digital signals generated in a respective modem/driver 114 via a back-end interface 130, wherein the signals are converted to a form suitable for processing by a digital channel board (DCB) 132. The digitized signals are processed in DCB 132 to simulate such effects as noise, fading, attenuation, delay and Doppler shift associated with a corresponding transmission, based on a model of expected motion of a specific UUT 36 (such as traveling in an automobile) and expected environment considerations, such as reflections from buildings in a path between the UUT and the base station or stations with which it is in communication. The principles of the simulation are generally similar to those described in patent application {file 31554. Number will be put in here.}, which is assigned to the assignee of the present invention and whose disclosure is incorporated herein by reference, although the implementation is adapted for the conditions of terrestrial, cellular communications, rather than satellite communications. The output of each DCB 132 is converted to RF signals by a respective front-end RF interface 134. Preferably, the RF signals are then transferred to an adjustable RF gain matrix 154, which directs signals between unit 30 and the one or more UUTs 36. Alternatively, an RF splitter/combiner 136 receives the RF signals and conveys them directly to a single UUT 36.

On a reverse link of the unit, RF signals output by each of UUTs 36 are directed to multiple paths, corresponding to different sectors, by gain matrix 154. Alternatively, signals from a single UUT are aplit by splitter/combiner 136 and input to each DCB 132 via respective front-end RF interfaces 134. Each DCB 132 incorporates effects for the reverse link generally similar to those described above for the forward link. The processed signals from DCB 132 are then output via back-end interface 130 to appropriate modem/drivers 114. Channel effects such as those described hereinabove are incorporated into test environment 50 by a combination of hardware and software. The channel effects will most preferably change at a maximum rate of 100 Hz (corresponding to a period of 10 ms) according to behavior patterns incorporated into test environment 50. It will be appreciated that channel effects may also remain constant or be repeated with a cycle time larger than 10 ms.

A channel control unit 144 provides synchronization and control signals to the other elements of unit 30 and exchanges simulation data therewith. Control unit 144 can be programmed by controller 24 using a remote control unit 146, and/or via network 40. The control unit can also be coupled to off-the-shelf test equipment 148, for evaluating the performance of unit 30.

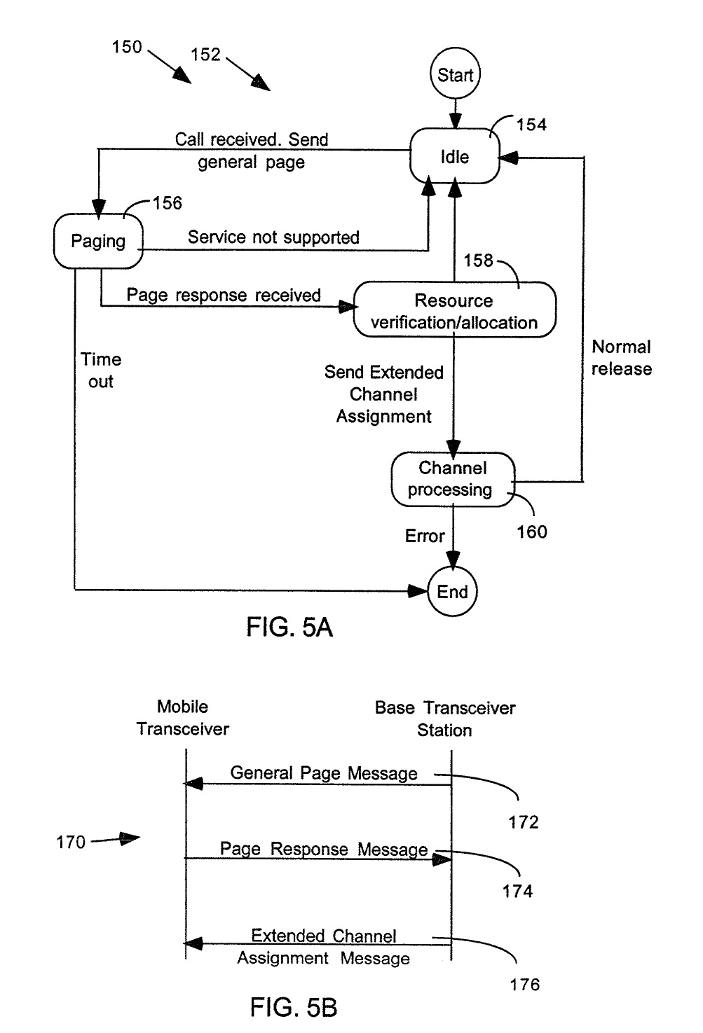

FIG. 5A is a state chart 150 illustrating a call setup procedure 152 followed by one of BSCs 23, and FIG. 5B is a message flow diagram 170 showing messages transferred when the setup procedure occurs, according to a preferred embodiment of the present invention. As explained in more detail below, simulations of procedures such as procedure 152 are incorporated into test configuration 50. State chart 150 represents a setup procedure followed by a specific BSC 23 (FIG. 1) in network 25 when a call from land-based telephone 33 is made to a specific cellular mobile unit 35. It will be understood that state chart 150 is used herein as an example illustrating one procedure followed by a specific BSC 23, and those skilled in the art will be able to generate state charts of other procedures followed by the one or more BSCs 23.

The call setup procedure illustrated by chart 150 is invoked when a land-based call is received by BSC 23, which is initially in an idle state 154. BSC 23 transfers to a paging state 156, wherein a general page message 172, comprising a specification of a type of service, typically voice service, required by BSC 23, is sent from BSC 23 to the specific mobile called by the land-based telephone. If no response is received within a preset time the call setup procedure terminates; if BSC 23 is not able to provide services required for the call to be completed, the BSC returns to idle state 154. If the mobile is able to answer the general page message, it sends a page response message 174 to the BSC. When BSC 23 receives page response 174, the BSC transfers to a resource verification/allocation state 158. In state 158 BSC 23 checks that resources in the form of traffic channels are available for the call, allocates the resources, and sends an extended channel assignment message 176 to the mobile. BSC 23 then transfers to a channel processing state 160, wherein the BSC remains while the call proceeds. When the call is terminated, the assigned traffic channel is released and BSC 23 returns to idle state 154. If while the call is proceeding the call is unable to continue, for example if the mobile does not acknowledge signals sent to it, the call setup procedure terminates.

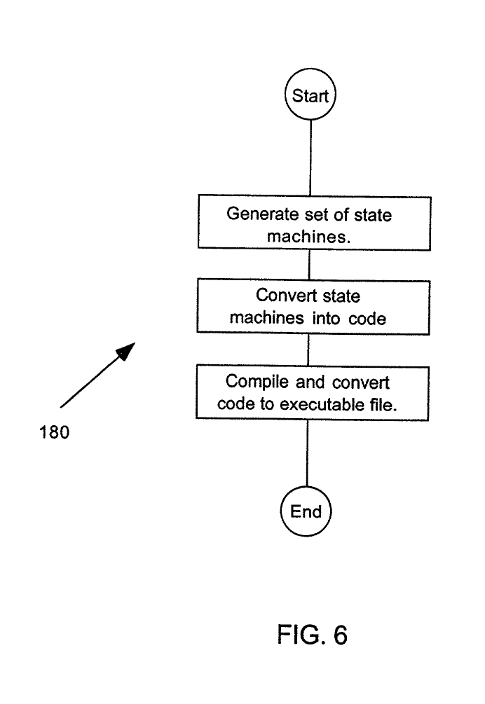

FIG. 6 is a schematic flow chart illustrating a process 180 used to produce a behavioral model executable file, according to a preferred embodiment of the present invention. Each executable file produced according to process 180 corresponds to a specific behavior model 55, referred to hereinabove with reference to FIG. 2, which is run on system 20. Each behavior model 55 corresponds to a specific test scenario for system 20, and each user 27 is able to generate one or more behavioral model executable files, according to one or more test scenarios that the user requires run on UUTs 36.

In a first step, a set of one or more state machines is generated as respective graphical state charts. Each state chart in the set is generally of the form described with respect to FIG. 5A. Most preferably, each state chart corresponds to one of the procedures defined in a standard, as described in the Background of the Invention, according to which network 25 operates. Further most preferably, each state chart is drawn in an industry-standard program, such as Visio Enterprise, which enables a computer readable file, herein assumed to be in UML (Universal Modeling Language), to be generated corresponding to the state chart.

In a conversion step, each state chart in the set is converted to UML, and each UML file is then parsed and converted to a corresponding concurrent hierarchical state machine (CHSM) language file. The CHSM files are then combined into a CHSM file-set representing the set of one or more state machines.

In a final step, the CHSM file-set is compiled in an industry-standard computer language such as C++. The compiled file is converted into a behavior model executable file corresponding to the one or more state machines of the first step of process 180.

It will be appreciated that process 180 is an example of one method for producing an executable file corresponding to one or more state machines, which state machines in turn correspond to respective procedures followed by a specific BSC 23. Those skilled in the art will be able to use other methods for performing the conversion, such as converting the state machines to code in the PERL language and compiling the converted code to an executable file.

It will thus be appreciated that the preferred embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. Apparatus for testing one or more mobiles, each mobile being adapted to transmit and receive respective signals compatible with a cellular communications network, the apparatus comprising:
station simulation circuitry, which is adapted to simulate a plurality of base station controllers (BSCs) operative simultaneously in the cellular communications network; and
mobile interface circuitry, which is coupled to transfer the respective signals between the station simulation circuitry and the one or more mobiles.

2. Apparatus according to claim 1, wherein the mobile interface circuitry comprises channel simulation circuitry, which is adapted to simulate one or more communication channels via which the respective signals are conveyed between the station simulation circuitry and the one or more mobiles.

3. Apparatus according to claim 2, wherein the channel simulation circuitry comprises one or more digital circuit boards (DCBs), wherein the one or more DCBs are adapted to simulate one or more of effects selected from a group consisting of noise, fading, attenuation, delay, Doppler shift, and reflection.

4. Apparatus according to claim 1, wherein the station simulation circuitry comprises one or more components adapted to simulate one or more base station transceivers coupled to the plurality of BSCs.

5. Apparatus according to claim 1, wherein the station simulation circuitry is adapted to transfer data to and from a public switched telephone network (PSTN).

6. Apparatus according to claim 1, wherein the station simulation circuitry is adapted to transfer data chosen from a group consisting of asynchronous data, fax data, and packet data.

7. Apparatus according to claim 1, and comprising a system controller coupled to the station simulation circuitry and the mobile interface circuitry, which system controller enables a plurality of users to test the one or more mobiles simultaneously.

8. Apparatus according to claim 7, wherein the controller comprises a database wherein are stored one or more parameters defining the plurality of BSCs.

9. Apparatus according to claim 8, wherein the database comprises parameters defining a plurality of topologies describing connections between the plurality of BSCs.

10. Apparatus according to claim 8, wherein the database comprises one or more behavior models, wherein each of the one or more behavior models describes one or more procedures followed by at least one of the plurality of BSCs.

11. Apparatus according to claim 8, wherein the database comprises one or more test scripts input by the one or more users for testing the one or more mobiles.

12. Apparatus according to claim 11, wherein the one or more test scripts comprise one or more executable files respectively defining one or more procedures followed by at least one of the plurality of BSCs.

13. Apparatus according to claim 11, wherein the one or more test scripts comprise scripts written in Tree and Tabular Combined Notation (TTCN).

14. Apparatus according to claim 1, wherein the station simulation circuitry is adapted to simulate management of communication channels of the plurality of BSCs.

15. Apparatus according to claim 14, wherein the communication channels comprise communication channels selected from a group consisting of pilot, paging, synchronization, and access channels.

16. Apparatus according to claim 14, wherein the communication channels comprise forward and reverse dedicated communication channels.

17. Apparatus according to claim 1, wherein the one or more mobiles comprise one or more mobile station modem devices.

18. A method for testing one or more mobiles, each mobile being adapted to transmit and receive respective signals compatible with a cellular communications network, the method comprising:
processing the respective signals in station simulation circuitry so as to simulate operation of a plurality of base station controllers (BSCs) in communication with the one or more mobiles in the cellular communications network, thus to produce processed signals; and
transferring the processed signals between the station simulation circuitry and the one or more mobiles.

19. A method according to claim 18, wherein transferring the processed signals comprises simulating one or more communication channels used to transfer the signals.

20. A method according to claim 19, wherein simulating the one or more communication channels comprises simulating one or more of effects selected from a group consisting of noise, fading, attenuation, delay, Doppler shift, and reflection in channel simulation circuitry.

21. A method according to claim 18, wherein processing the signals comprises processing the signals so as to simulate operation of one or more base station transceivers coupled to the plurality of BSCs.

22. A method according to claim 18, wherein testing the one or more mobiles comprises testing the one or more mobiles under control of a plurality of users simultaneously.

23. A method according to claim 18, wherein testing the one or more mobiles comprises inputting one or more test scripts to the station simulation circuitry.

24. A method according to claim 18, wherein processing the signals comprises defining one or more topologies describing connections between the plurality of BSCs, and processing the signals in accordance with at least one of the defined topologies.

25. A method according to claim 18, wherein processing the signals comprises constructing one or more behavior models, wherein each of the one or more behavior models describes one or more procedures followed by at least one of the plurality of BSCs, and processing the signals in accordance with at least one of the behavior models.

26. A method according to claim 18, and comprising simulating management of communication channels of the plurality of BSCs.

27. A method according to claim 18, wherein testing the one or more mobiles comprises testing one or more mobile station modem devices.
